(19) United States
(12) Patent Application Publication
(10) Pub. No.: US 2017/0083785 A1
(43) Pub. Date: Mar. 23, 2017

(54) METHOD AND SYSTEM FOR IMPROVED OPTICAL CHARACTER RECOGNITION

(71) Applicant: AppCard, Inc., Wilmington, DE (US)

(72) Inventors: Idan Miron Warsawski, Lexington, MA (US); Amichay Oren, Tenafly, NJ (US); Yair Goldfinger, New York, NY (US)

(21) Appl. No.: 15/311,373

(22) PCT Filed: May 14, 2015
(86) PCT No.: PCT/US15/30861

§ 371 Date: Nov. 15, 2016

Related U.S. Application Data
(60) Provisional application No. 61/994,522, filed on May 16, 2014.

(51) Int. Cl. G06K 9/46; G06K 9/62

(52) U.S. Cl. CPC G06K 9/4671; G06K 9/6292; G06K 2209/01

(57) ABSTRACT

Described herein are systems and methods for performing optical character recognition in documents such as, in certain embodiments, a printed receipt from the sale of an item. In certain embodiments, the systems utilize a time dimension associated with inputs—for example, the expectation that the system will identify components in future related inputs—in order to increase speed and accuracy. The processing time and computing resources required diminish for each subsequent processing stage, and the embodiments described herein have the ability to self-train, attempting computationally more complicated algorithms in the case of a non-match or ambiguous result at previous stage.

### CROSS REFERENCE TO RELATED APPLICATIONS

This application claims priority to and the benefit of U.S. Provisional Application No. 61/994,522, filed May 16, 2014, the contents of which are hereby incorporated by reference herein in their entirety.

### TECHNICAL FIELD

This invention relates generally to optical character recognition.

### BACKGROUND

OCR, or Optical Character Recognition, is the technique of extracting rasterized text and other metadata from images. While OCR accuracy has improved substantially over the years, results with small fonts and sparse text can be very poor with different types of errors introduced, e.g., simple errors such as confusing the letter “0” with the number “0” (zero), or confusing the number “1” (one) with the lowercase letter “1” or the uppercase letter “I”, as well as completely incorrect results, including missed words or characters. Modern OCR engines can be trained to increase accuracy, but many still require human intervention at every stage. In addition, such training does not guarantee the prevention of future occurrences of the same or similar type of errors, even when implemented with existing classifier and hinting engine designs.

There is a need for improved character recognition techniques that offer improved accuracy and improved efficiency (e.g., using less processing time).

### SUMMARY OF THE INVENTION

Described herein are systems and methods for performing optical character recognition in documents such as, in certain embodiments, a receipt (in printed or digital form) from a point of sale (“POS”) or Enterprise Resource Planning (“ERP”) software.

Embodiments described herein provide improved speed, accuracy, and adaptability. In certain embodiments, the technique utilizes a time dimension associated with inputs—for example, the expectation that the system will identify components in future related inputs—in order to increase speed and accuracy. The processing time and computing resources required diminish for each subsequent processing stage, and the embodiments described herein have the ability to self-train, attempting computationally more complicated algorithms in the case of a non-match or ambiguous result at a previous stage. In certain embodiments, the system provides monitoring and/or logging subsystems that allow the review of possibly incorrect results and the replay of incorrect inputs.

In one aspect, the invention is directed to a method for extracting rasterized text and/or other metadata from an image, the method comprising the steps of: accessing, by a processor of a computing device, a first page of a first document (e.g., an electronic document, or a scanned physical document) comprising one or more pages; performing A and/or B: (A) identifying, by the processor, a set of unique words on the first page by performing a hashing algorithm and storing, as a word-to-page mapping structure, a representation (e.g. a hash) for each identified unique word and an associated (e.g., mapped) identification of one or more locations on the first page (e.g., one or more coordinates) at which said unique word appears; and identifying, by the processor, a set of unique glyphs on the first page and, for each glyph, storing, as a glyph-to-word mapping structure, an associated (e.g., mapped) identification of one or more words of the set of unique words in which the glyph appears; and reconstructing, by the processor, (i) the set of unique words using the glyph-to-word mapping structure and (ii) the arrangement of words on the first page using the word-to-page mapping structure; (B) identifying, by the processor, a set of unique glyphs on the first page and, for each glyph, storing, as a glyph-to-page mapping structure, an associated (e.g., mapped) identification of one or more coordinates on the page at which the glyph appears; and reconstructing, by the processor, the arrangement of glyphs on the first page using the glyph-to-page mapping structure.

In certain embodiments, the method comprises identifying, by the processor, one or more image elements on the first page corresponding to graphical features not requiring further segmentation, and removing said one or more identified image elements from the first page prior to performance, or continued performance, of the hashing algorithm on the first page (e.g., removing lines and/or boxes from the first page prior to segmenting underlined words and/or words within a table on the first page). In certain embodiments, the method comprises storing hinting information during the identifying of the set of unique glyphs, and using the stored hinting information during the reconstructing step (e.g., thereby providing accurate reconstruction of identified glyphs into words and/or appropriate arrangement of words on the first page). In certain embodiments, the stored hinting information comprises one or more members selected from the group consisting of a hardcoded rule, a dictionary word lookup, a virtual machine hinting instruction of a recognized font file, and an instruction of a customized virtual machine.

In certain embodiments, one or both of (i) the step of identifying the set of unique words on the first page and (ii) the step of identifying the set of unique glyphs on the first page comprises using metadata identified by the processor to classify an identified image element on the first page as one of the unique words or one of the unique glyphs (e.g., wherein the metadata comprises one or more of a height, a width, and/or an aspect ratio of an identified image element on the first page).

In certain embodiments, the step of identifying the set of unique glyphs comprises identifying, by the processor, a segmented glyph that is not readily identifiable using a first OCR engine and identifying at least one of the one or more words in which the segmented glyph is determined by the processor to appear, then using a second OCR engine to identify the segmented glyph that was not identifiable using the first OCR engine, wherein the second OCR engine comprises one or more rules associated with glyphs surrounding the unknown segmented glyph in the one or more words in which the segmented glyph appears.

In certain embodiments, the step of identifying the set of unique glyphs comprises identifying, by the processor, a segmented glyph classified by a first OCR engine with a confidence score below a predetermined threshold, then classifying the segmented glyph using at least a second OCR engine (and, optionally, one or more subsequent OCR engines), then identifying, by the processor, a classification of the segmented glyph based on a confidence score achieved by the second and/or subsequent OCR engine(s).

In certain embodiments, one or more of (i) the step of identifying the set of unique words on the first page, (ii) the step of identifying the set of unique glyphs on the first page, and (iii) reconstructing the set of unique words and the arrangement of words on the first page, comprises using rules and/or data stored during a previous performance of the method of extracting rasterized text and/or other metadata of a second document (e.g., wherein the method is self-training).

In certain embodiments, the first document is a receipt (e.g., a printed receipt).

In another aspect, the invention is directed to a system for extracting rasterized text and/or other metadata from an image, the system comprising a processor and a memory, the memory storing instructions that, when executed by the processor, cause the processor to: access a first page of a first document (e.g., an electronic document, or a scanned physical document) comprising one or more pages; perform (A) and/or (B): (A) identify a set of unique words on the first page by performing a hashing algorithm and store, as a word-to-page mapping structure, a representation (e.g. a hash) for each identified unique word and an associated (e.g., mapped) identification of one or more locations on the first page (e.g., one or more coordinates) at which said unique word appears; identify a set of unique glyphs on the first page and, for each glyph, store, as a glyph-to-word mapping structure, an associated (e.g., mapped) identification of one or more words of the set of unique words in which the glyph appears; and reconstruct (i) the set of unique words using the glyph-to-word mapping structure and (ii) the arrangement of words on the first page using the word-to-page mapping structure; (B) identify a set of unique glyphs on the first page and, for each glyph, store, as a glyph-to-page mapping structure, an associated (e.g., mapped) identification of one or more coordinates on the page at which the glyph appears; and reconstruct the arrangement of glyphs on the first page using the glyph-to-page mapping structure.

In certain embodiments, the instructions cause the processor to identify one or more image elements on the first page corresponding to graphical features not requiring further segmentation, and remove said one or more identified image elements from the first page prior to performance, or continued performance, of the hashing algorithm on the first page (e.g., removing lines and/or boxes from the first page prior to segmenting underlined words and/or words within a table on the first page). In certain embodiments, the instructions cause the processor to store hinting information during the identifying of the set of unique glyphs, and use the stored hinting information during the reconstructing step (e.g., thereby providing accurate reconstruction of identified glyphs into words and/or appropriate arrangement of words on the first page). In certain embodiments, the stored hinting information comprises one or more members selected from the group consisting of a hardcoded rule, a dictionary word lookup, a virtual machine hinting instruction of a recognized font file, and an instruction of a customized virtual machine. In certain embodiments, the instructions cause the processor to use metadata identified by the processor to classify an identified image element on the first page as one of the unique words or one of the unique glyphs (e.g., wherein the metadata comprises one or more of a height, a width, and/or an aspect ratio of an identified image element on the first page). In certain embodiments, the instructions cause the processor to identify a segmented glyph that is not readily identifiable using a first OCR engine and identify at least one of the one or more words in which the segmented glyph is determined to appear, then use a second OCR engine to identify the segmented glyph that was not identifiable using the first OCR engine, wherein the second OCR engine comprises one or more rules associated with glyphs surrounding the unknown segmented glyph in the one or more words in which the segmented glyph appears. In certain embodiments, the instructions cause the processor to identify a segmented glyph classified by a first OCR engine with a confidence score below a predetermined threshold, then classify the segmented glyph using at least a second OCR engine (and, optionally, one or more subsequent OCR engines), then identify, by the processor, a classification of the segmented glyph based on a confidence score achieved by the second and/or subsequent OCR engine(s). In certain embodiments, the instructions cause the processor to use previously-stored rules and/or data to do any one or more of (i), (ii), and (iii), as follows: (i) identify the set of unique words on the first page, (ii) identify the set of unique glyphs on the first page, and (iii) reconstruct the set of unique words and the arrangement of words on the first page. In certain embodiments, the first document is a receipt (e.g., a printed receipt).

In another aspect, the invention is directed to a method for extracting rasterized text and/or other metadata from an image, the method comprising the steps of: accessing, by a processor of a computing device, a first page of a first document (e.g., an electronic document, or a scanned physical document) comprising one or more pages; accessing, by the processor, a set of glyphs from a glyph data store; for each member of the set of glyphs, scanning, by the processor, the first page of the first document to identify each occurrence of the member on the page, identifying an (x,y) coordinate for each occurrence, and generating a resulting glyph-to-page mapping structure; reconstructing, by the processor, the arrangement of glyphs on the first page using the glyph-to-page mapping structure.

In certain embodiments, the method further comprises applying, by the processor, a filter to identify and reconcile overlapping and/or erroneous matches in the glyph-to-page mapping structure prior to (or contemporaneous with) the reconstructing of the arrangement of glyphs on the first page.

Features relating to embodiments of one aspect of the invention can be used with respect to another aspect of the invention. For example, features of a claim depending from an independent method claim can apply to a system claim as well, and features of a claim depending from an independent system claim can apply to a method claim as well.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a flow chart of a method for improved optical character recognition of a page of a document, according to an illustrative embodiment.

FIG. 2, comprised of 2(I) and 2(II), is a flow chart of a segmentation queue and a classifier match subroutine in a method for improved optical character recognition, according to an illustrative embodiment.

FIGS. 3A-3E, comprised of 3A(I), 3A(II), 3B, 3C, 3D, and 3E, are flow charts and schematics of illustrative subroutines for identification of problem glyphs and/or words in a method for optical character recognition of a page, according to an illustrative embodiment.

FIG. 4 is a block diagram of an example network environment for use in the methods and systems for improved optical character recognition, according to an illustrative embodiment.

FIG. 5 is a block diagram of an example computing device and an example mobile computing device, for use in illustrative embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

It is contemplated that systems, devices, methods, and processes of the claimed invention encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

As used herein, the term “document” is understood to mean a set of one or more images, each image representing one or more pages of the document. As used herein, the term “image” is understood to mean a physical graphical display or any data representation that may be interpreted for visual display. For example, an image may be a physical graphical display, or in another example, an image may be a dataset of values representing intensity levels over a two-dimensional grid of pixels. A “document” or an “image” may include, as non-limiting examples, traditional image files (e.g., a rasterized image file, such as a Portable Network Graphics (PNG) file, a Joint Photographic Experts Group (JPG, JPEG) file, a bitmap (BMP) file, and the like), files with embedded images therein (e.g., a Portable Document Format (PDF) file), as well as any raw binary stream with repetitive structures identified by markers.

As used herein, a “page” is any subset of a document. The document may be a single-page document, or it may be divided into a series of multiple pages which are sequential, that is, the information presented in the document proceeds from a first page, to a second page, and so on.

As used herein, a “word” is a discrete set of consecutive glyphs that go together, e.g., a set of individual marks that represent letters, numbers, punctuation, and/or other symbols, that, together, represent a written word, a written number, or abstract concept behind either.

In certain embodiments, the OCR techniques described herein include inputting a page, analyzing its layout to extract out individual words (segmentation), and then running a hashing algorithm on each individual word to generate and/or identify a unique word set on the page. The hashing algorithm detects identical words that appear on a page (such as the word “the”, or repeat prices on a receipt). As used herein, a hashing algorithm is one that maps data of variable length to data of a fixed length. A value returned by a hash function may be referred to as a hash value, hash code, hash sum, checksum, or simply a hash.

Examples of hashing algorithms that can be used here include, for example, but not limited to, traditional binary data hashes (such as MD5 or SHA1), and/or perceptual hashes (such as pHash, or similar). The hashing algorithm allows the present system to not have to perform the entire algorithm on duplicate instances of words. Where the hashing algorithm is computationally quicker than later OCR stages, this provides a significant speed increase.

The following describes illustrative implementations of the OCR methods and systems described herein. Headers are provided for the convenience of the reader—they are not intended as limiting.

### Page Level Segmentation

The segmentation engine stores, e.g., in cache or persistent memory, the original coordinates of each segmented word on the page along with its hash to be used in the later reconstruction stages. In some implementations, the coordinates includes x,y positions relative to a origin point (e.g., a corner of a page). In other implementations, the coordinates include an initial x,y position on a page followed by delta positions from that initial position.

During this segmentation stage, in some implementations, a number of configurable classifiers and processors is used to correctly detect and process elements such as barcodes, tables, lines, shapes, and drawings. In some implementations, these classifiers run at various times during the segmentation process, and alter the data flow for the specific image element upon which they run. Specifically, these classifiers, in some implementations, use various pieces of information from the image element to determine if an image modification operation is needed before continuing with segmentation (such as removing a bounding table), or completely remove the image element from further processing steps (e.g. if a barcode is detected it is decoded and removed from the segmentation queue). The classifier uses, in some implementations, metadata to improve the processing. The metadata used by the classifiers, in some implementations, includes simple metrics, e.g., height, width, aspect ratio. In other implementations, the metadata are derived from more complex image processing operations.

### Identification of Letters/Glyphs in Each Identified Word

During the next stage (which follows the segmentation stage in certain implementations), each unique word is processed by a segmentation algorithm to extract, when possible, letters or glyphs in each of the unique words. The segmentation algorithm, in some implementations, is the same as, or similar to, the one used in the page level segmentation. In other implementations, the segmentation algorithm in this identification stage is a different algorithm. In addition, the algorithm used does not necessarily need to be the same between words. The output of the algorithm is a representation of each letter/glyph inside of each word. In some implementations, the system performs a hashing operation, e.g., as described above, to identify a unique set of letter glyphs found throughout all words. The system may maintain a reverse mapping of the hash operation to be used for a subsequent reconstruction stage. In some implementations, the hashing algorithm used in this stage is the same as that used in other stages. In other implementations, different hashing algorithms are used.

During the hashing operation, the unique list of glyph/letter hashes, in some implementation, is queried from a secondary storage (e.g., a database or a memory cache). The database returns the glyph/letter results, optionally adding hinting information that is used in the reconstruction phase. The hinting results may include available overrides for certain ambiguous letters, character spacing and combination information, and other metadata that can be used in further processing steps to increase accuracy.

In the case in which the full list of letter/glyph hashes is found, the method, in some implementations, skips to the reconstruction steps. If the full list is not found, the system, in some implementations, attempts a number of progressively more complicated techniques to try and decipher each unknown glyph/letter.

### Reconstruction Step

The reconstruction stage involves, in some implementations, recreating each unique word by substituting the results from the previous hash lookup operation using the glyph-to-word mapping structure. The system then substitutes each word into the page of the document (e.g., original receipt) using the page-to-word mapping structure. The output at this point of the stage is a data file consisting of each glyph and its location on the original page as, e.g., a plain text file. However, word spacing and line breaks are often also required to fully reconstruct the page. Using the layout structure identified earlier, the system, in some implementations, adds the appropriate amount of whitespace and new lines, e.g., based on the stored coordinates of each word. In some implementations, to reduce or prevent erroneous layout generation (such as a word with an abnormally large space between characters that gets segmented as two words), the system uses, in some implementations, the hinting information queried from the database, or other runtime configurations, within an additional or second reconstruction pass, to improve accuracy. The post reconstruction hinting operation, in some implementations, executes hardcoded rules, dictionary word lookups (e.g. spell check), or rules attached to or associated with each character. In some implementations, this hinting operation includes using the recognized font file's virtual machine (VM) hinting instructions, or a custom VM.

The resulting input ID and used character ID's, in some implementations, are then stored in a database table for later review. Identified errors in some implementations, are subsequently queried, fixed and reprocessed.

### Identifying Problem Glyphs

In some implementations, where not every segmented glyph is readily identifiable from the database, further processing is performed, e.g., using a number of more complicated techniques to recognize the underlying glyph. A number of factors can cause a glyph to not be found in the database, despite having a full training set (all characters and numbers for all fonts we see in the input set). Examples of these factors include: characters which the configured segmentation algorithm cannot separate (such as connected or overlapping characters); characters with effects such as italics, strikeout, or dithering; and new characters not in the training data set or this specific input source. In addition, in the case of a new input source, it may be beneficial to populate and train the basic character set for the first time. It is contemplated that the training would efficiently improve the later processing, thereby saving time and money, e.g., in the review process.

The techniques used to identify the characters, in some implementations, are configured individually for each input source, and then chained together. Examples are described in more detail below.

In some embodiments, the system uses a general-purpose OCR engine. For example, the processor feeds each word in which the unknown letter/glyph was found as an input into a general-purpose OCR engine, identifies the resulting raw output from the engine, and attempts to find the single unknown glyph from the raw output. In some implementations, the processor substitutes only the unknown glyph, while still giving the OCR engine the full word to process, e.g., to increase the overall accuracy. In the case in which the unknown letter/glyph was found across multiple words, in some implementations, the processor performs an OCR operation on all words containing the unknown letter/glyph and uses the majority output as the definitive classification. In some implementations, the majority output is used for further processing.

Embodiments herein may employ more than one OCR engine of different types and/or configurations. In some embodiments, the processor feeds the unknown letters/glyphs/words into multiple OCR engines, and uses a simple majority algorithm (or other algorithm) to choose the most likely correct classification. In addition, in some implementations, the system determines a confidence score of the accuracy of the classified glyph. The score is then used, in some implementations, to trigger alerts or to stop the processing. These actions, in some implementations, are based on programmable thresholds for the required accuracy.

In some implementations, contextual clues from the known surrounding glyphs are used to further increase the overall accuracy and/or speed. These contextual cues may include spacing information, input language, and grammatical rules and expected structure. Examples of such cues include, in some implementations, those used in spell check algorithms.

Certain embodiments employ a more advanced segmentation algorithm. For example, in the case of two letters which are barely touching, such as two uppercase “T”s, the processor segments the letters and checks the database to determine whether the segmented results are both known and verified characters. If the segmented results are both verified, in some implementations, the processor then assumes that the combination is therefore also verified, and updates the database and/or cache to avoid this processing the next time the combination is identified.

Certain embodiments use a more advanced letter recognition decision tree algorithm, which attempts to detect a letter by scanning it by its reading order and traversing a training tree generated from a database of known characters. In the case of letters overlapping, the processor, in some implementations, performs an “exclusive-or” operation (XOR) of the original character once identified, and moves to the next character. For instances of characters that are overlapping and not just touching, the system starts, in some implementations, at a different point in the tree/graph (i.e. pixel 3 instead of pixel 1). This algorithm, in some implementations, uses a strict lookup/tree jump. In other implementations, the algorithm uses a metric such as hamming distance and a weighted graph max flow algorithm to decide on which path to take, e.g., in the case of a glyph effect like dithering.

### Training

In some implementations, the system uses the result of the identification operation to self-train the algorithm for future iterations. In certain embodiments in which the result does not meet a desired or pre-specified confidence threshold, the problematic glyphs are flagged and placed into a review queue to be reviewed by a person. The reviewed glyphs are then stored for use in subsequent OCR analysis/training rounds.

In some implementations, the processor uses a known character set (the database, possibly partitioned by known characters in use by the given input vertical), and instead of (or in addition to) hashing, performs an image-matching algorithm for each glyph against the full input. Some implementations of this operation is performed on a parallel processor, such as a GPU, multicore CPU, or dedicated hardware (FPGA or ASIC).

### Illustrative Applications—OCR Self-Training

In case a glyph is not found in the training data set, an attempt to self-train the system is possible. Since the algorithm retains (or is able to regenerate) a reverse glyph mapping to the original document, it is possible to have a number of configurable self-training modules available to look at the problematic glyph and return a possible output. By using the surrounding contextual information, such as surrounding known glyphs (other letters in a word), font information and input source information, the system assists in both increasing the accuracy of these modules and evaluating their possible accuracy. These methods are enabled or disabled, in some implementations, according to the needs of an input source. Multiple modules may be combined together, and their results are evaluated against each other in order to increase the accuracy of the system.

In one example, an external OCR engine evaluates a problematic glyph and return a result. The surrounding glyphs that make up the full word are used, in some implementations, as an input to the engine as well, even if the surrounding glyphs are known, in order to increase accuracy. This provides the external OCR engine more example glyphs to use to perform routines like font detection. In certain cases, the surrounding glyph metadata (such as font information and letter value) are used to guide the external OCR engine into providing more accurate results, by both restricting fonts to be searched and ensuring that the verified surrounding glyphs are their expected value. The verified glyphs and metadata are also used to evaluate the accuracy of the output of the external OCR engine. For example, if the surrounding letters are equal to their expected value, the unknown glyph has a higher likelihood of being accurate. In the case where certain glyphs in a word are known and verified, the known good results are used, in some implementations, instead of the external OCR results.

The mapping of unknown glyphs to words are additionally utilized, in some implementations, to increase accuracy by instructing the external OCR engine to analyze multiple words with the same glyph. For example, consider a single unknown glyph “S” appearing on a document, where the glyph is found in three unique words: “Subtotal”, “Sold” and “Snack”. The three words may be passed to the external OCR engine and an accuracy determination/best choice algorithm is used to determine the most accurate output. This accuracy determination algorithm, in some implementations, is i) similar to the contextual based algorithm described above, ii) implemented as a simple majority, or iii) evaluated based on the perceived accuracy of the outputs combined with the known metadata.

In situations where multiple external OCR engines are available, accuracy can be increased by leveraging a plurality of different algorithms. The unknown glyphs or words are passed, in some implementations, to each OCR engine, and the results of each engine are passed to an accuracy determination algorithm as mentioned before.

In certain cases, other non-OCR approaches are used to determine the unknown glyph. These approaches are used, in some implementations, in addition to, or instead of the OCR engines. The first example of such a technique is using a spell check engine to determine the missing glyph. In a word such as “Discount”, where the missing glyph is the letter “i”, a simple spell check or spell check query of the word “Dscount” will return back that the most likely correct word is “Discount”. The unknown glyph is then assumed to be an “i”. This approach improves the accuracy of the OCR engine by using the reverse glyph mapping to the document. In the case of multiple words containing the missing glyph, or the usage of a combination of non-OCR and external OCR methods, another accuracy determination algorithm, such as a simple majority, may be used. In certain implementations, the input word set for the spell check algorithm includes a custom training set retrieved from the database.

Another example of a non-OCR technique involves the handling of certain problematic character effects such as two connected glyphs such as two uppercase “T”s connected by their top bar. More advanced segmentation algorithms are used, in some implementations, to separate out the connected glyphs (e.g., two connected Ts) into their component glyphs (individual Ts). If the component glyphs are found in the training set and are verified as accurate, the combination of the two glyphs is assumed to be accurate, and the dataset is retrained with the glyph combination for future occurrences.

### Hashing

In some implementations, a hashing algorithm is used to provide a unique signature for each glyph within the find-duplicate-words stage and/or find-duplicate-glyphs stage of the present OCR engine. It is possible to perform this function, in some cases, without the use of a hashing algorithm, e.g., by simply searching the training set for variable length binary signature. This may require performing much larger binary lookups, which can affect processing speed.

In some implementations, the binary data (pixel values) of the glyph, and the dimensions (height and width) of the glyph are used as the input to the hashing algorithm. In cases where the inputs are in different pixel formats, such as the field ordering of the RGB pixels, or a different color space such as CMYK, or glyphs in different color, the data are pre-processed, e.g., normalized to a predetermined value before being hashed, to better utilize the training set.

Possible binary hashes that may be used include, for example, but not limited to, those associated with the Secure Hash Algorithm (SHA) series (e.g., SHA-1, SHA-256, SHA-512, SHA-3), the MD5 message-direct algorithm, and the Race Integrity Primitive Evaluation Message Digest (RIPEMD) series. These hashes are all designed to avoid hash collisions (i.e., two different inputs that produce the same output), which would cause the wrong letter to be returned for that input. These hashes all have the property that a small change in the input causes a significant change in the output. It might be beneficial in some implementations to use an alternative-hashing algorithm where a small change in the input corresponds to a small change in the output.

Binary hashes are used, in some implementations, for the majority of the processing since they are typically very fast to compute and are easy to design the corresponding lookups. In situations where there are input effects, such as dithering or strike out text, binary hashes may fail despite the undistorted backing characters being known due to the anti-collision properties of most hashes. In these cases, a classifier (as mentioned before) is used, in some implementations, to detect such effects and, e.g., to change the processing path of the given glyphs to use a different hashing algorithm better suited for non-exact matches.

An example of this is the application of a blurring algorithm to the dithered text followed by a hashing algorithm that allows for a fuzzy match against the trained dataset. The hashing algorithm in this case is one that does not operate as a binary hash, but rather a perceptual one (such as pHash) or alternatively a binary hash that is designed to produces similar results for binary similar images. The results are then queried from a data store (e.g., a spatial database) that will return similar results and a final decision based on the similar results.

In the case of a problematic effect like strikeout text, a classifier is used, in some implementations, to remove the strikeout and to attempt a similar fuzzy match algorithm as described above.

In some implementations, instead of performing a hash on the minimum set of glyphs, if the training dataset is sufficiently limited, it is possible to instead scan over the input document with each member of the input dataset looking for potential matches. This is the reverse of the operation mentioned before—instead of performing a hash then a lookup, the algorithm is performing a query to limit the input dataset, and then individually searching for matches for each returned glyph. This operation may achieve a higher accuracy by having a trained dataset of glyphs for the search.

### Illustrative Algorithms

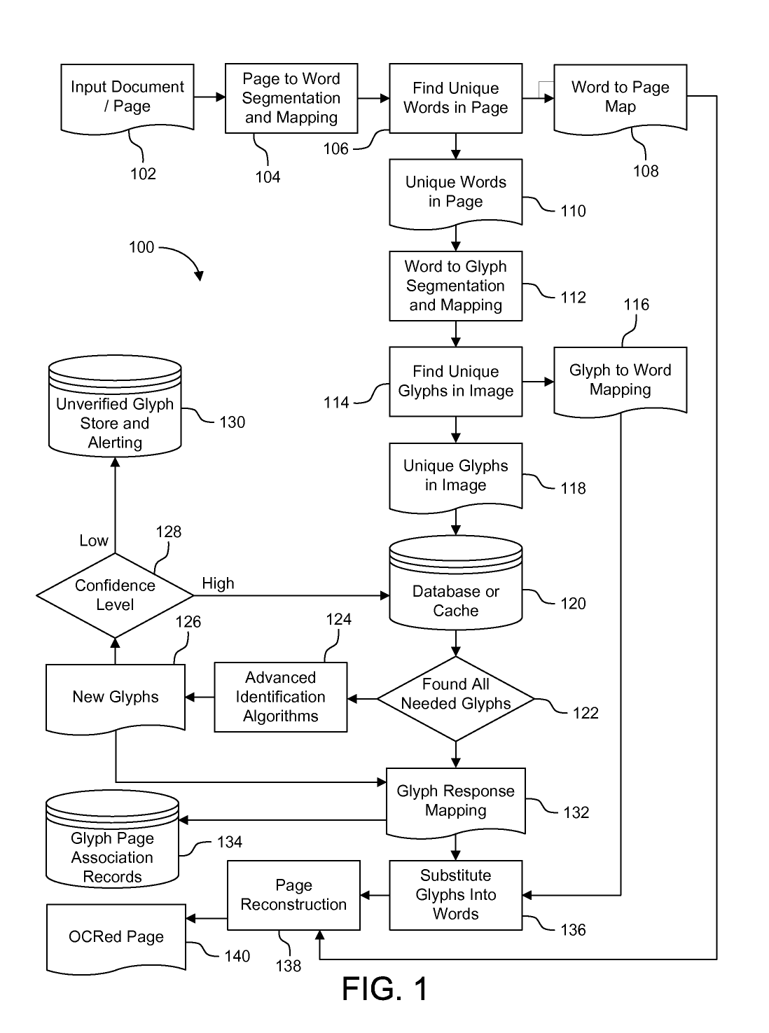

FIG. 1 is a flow chart of a method 100 for improved optical character recognition of a page of a document, according to an illustrative embodiment. The method may begin with a page 102 of a document being accessed for analysis by the processor of a computing device. In step 104, a routine for page-to-word segmentation and mapping is performed on the page 102. In step 106, image elements corresponding to unique words on the page 102 are identified by the processor, and a word-to-page map 108 is constructed. A word-to page map is, in some implementations, used in subsequent processing and includes, in some implementations, a representation (e.g. a hash) for each identified unique word and an associated (e.g., mapped) identification of one or more locations on the first page (e.g., one or more coordinates) at which said unique word appears. Unique words 110 found on the page 102 are then processed by word-to-glyph segmentation and mapping (step 112) to identify the glyphs that make up each unique word 110. Efficiency is gained by performing step 112 only once for each unique word 110, rather than for each instance of the word on the page.

The unique glyphs 118 in the words are identified (step 114), and glyph-to-word mapping 116 is generated (step 114). A glyph-to-word mapping is generated, in some implementations, for subsequent processing and includes, in some implementations, an associated (e.g., mapped) identification of one or more words of the set of unique words in which the glyph appears. In step 120, the unique glyphs 118 on the page 102 are compared to a database and/or cache to classify each glyph 118 (e.g., to identify the image element as a glyph, e.g., in the database and/or cache). The process 120 continues until all glyphs 118 are identified. If a given glyph 118 is determined to not be identifiable from the glyphs in the database/cache used in step 120 (step 122), then advanced identification algorithms are used in step 124, and new glyphs 126 are identified. In some implementations, a confidence level is determined in step 128, for each newly identified glyph 126. If the confidence level is determined in step 128 to be satisfactorily high (e.g., meets an acceptable, predetermined threshold), the glyph 126 is added to the database or cache used in step 120 to be subsequently used, e.g., in the identification of glyphs of other pages or other documents. If the confidence level identified in step 128 is low, the unverified glyph is stored (step 130), and an alert is triggered that possible additional analysis, or human intervention, is necessary to definitively identify the glyph and whether to include it in the database used in step 120.

Once all the glyphs are identified 118, glyph response mapping 132 is generated. Glyph page association records are stored (step 134). Then, glyphs are substituted into words (step 136) using the previously-created glyph-to-word mapping 116, and the page is reconstructed (step 138) by assembling the words on the page using the word-to-page map 108. The reconstructed page 140 is then outputted, e.g., for display, storage, printing, and/or transmission.

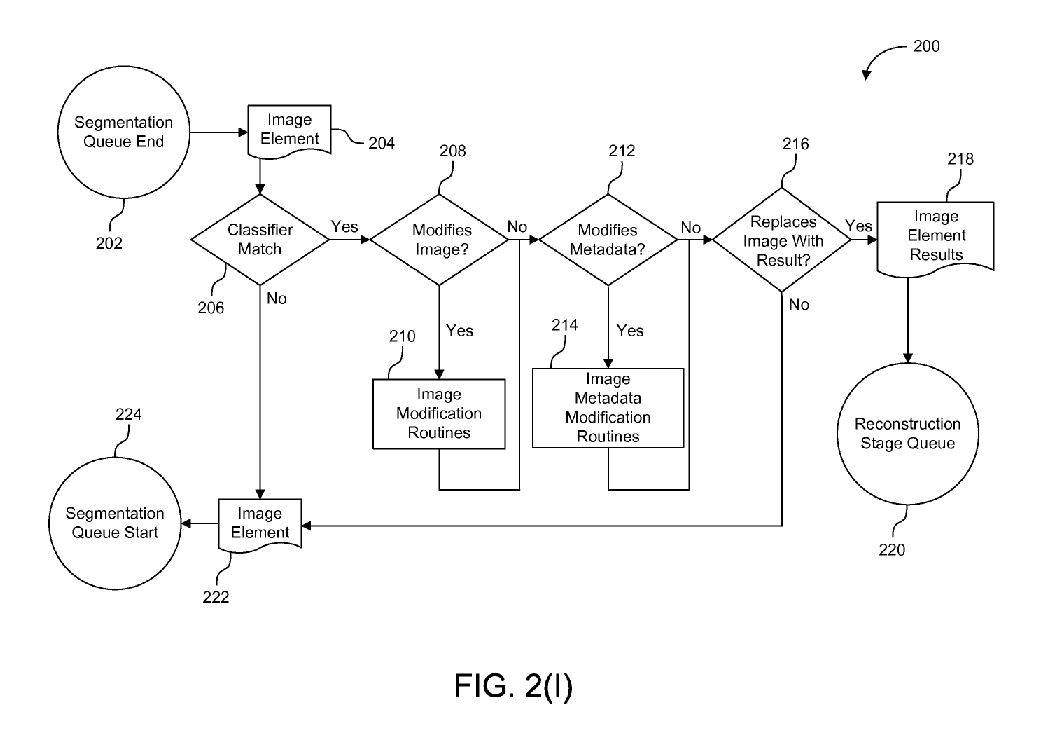

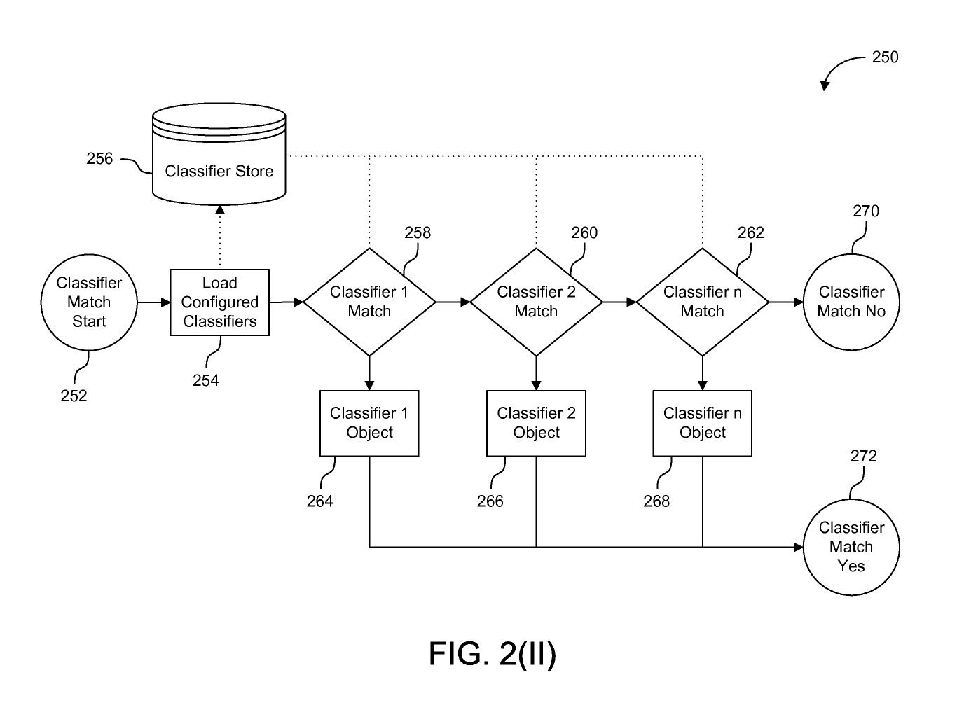

FIG. 2, shown in FIGS. 2(I) and 2(II), is a flow chart of image modification routines used during a segmentation process 200 and a flowchart of a classifier match subroutine 250, used in a method for improved optical character recognition, according to an illustrative embodiment. As shown in FIG. 2(I), an image element 204 is outputted at the end of a segmentation queue (step 202), and sent to a classifier match subroutine (e.g., 250) (step 206). The processor or classifier determines whether to pre-process the image element 204, e.g., initiate image modification routines (steps 208, 210) and/or image metadata modification routines (212, 214), depending on the result of the classifier match subroutine 206. Following the classifier matching subroutine 206 and pre-processing, if the identified image elements are determined to be replaceable with a result of the classifier (e.g., decoding a barcode) (step 216), the one or more results 218 are sent to the reconstruction stage queue (220), else the image element 222 is sent back to the segmentation queue start (step 224).

As shown in FIG. 2(II), the classifier match subroutine 250 begins at step 252. The classifier match subroutine 250 loads configured classifiers in step 254 from a classifier store 256. Classifiers 1 to n are used to match image elements against configured patterns (such as barcodes, grids and character effects) (steps 258, 260, 262, 264, 266, and 268), which determines whether or not a satisfactory classifier match (270, 272) is found. In the case a classifier match 272 is found, the classifier object (e.g., from steps 264, 266, 268) is returned, in some implementations, to the subroutine 200, e.g., to facilitate the modification routines (208, 212, 216).

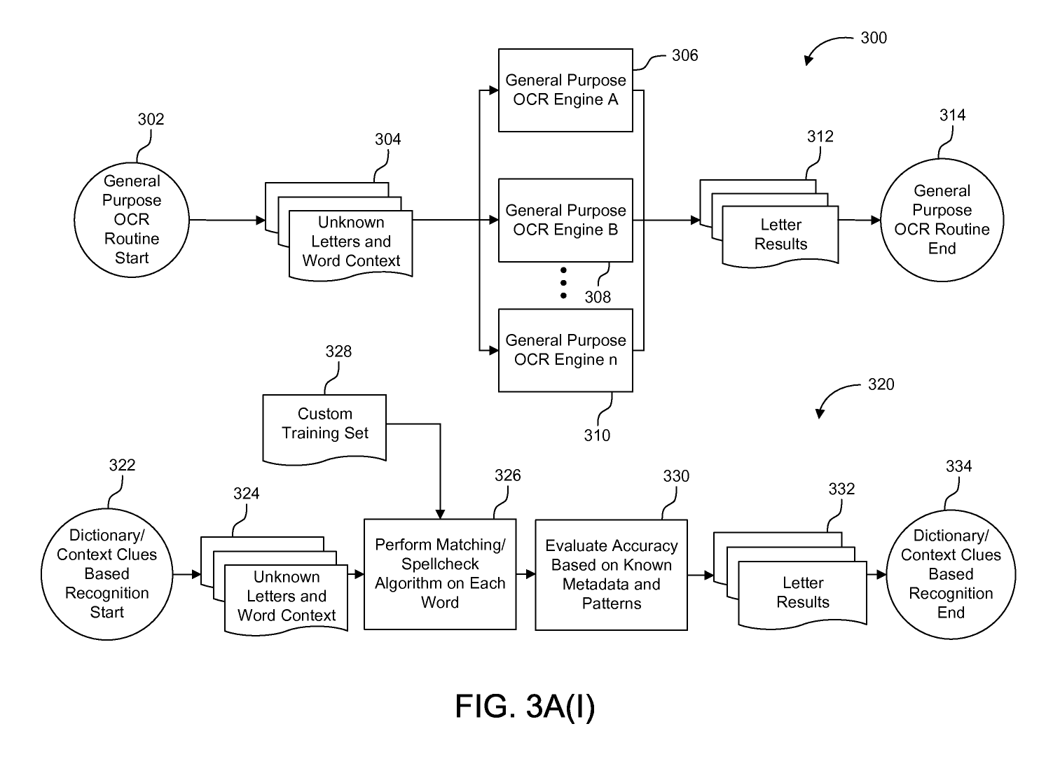

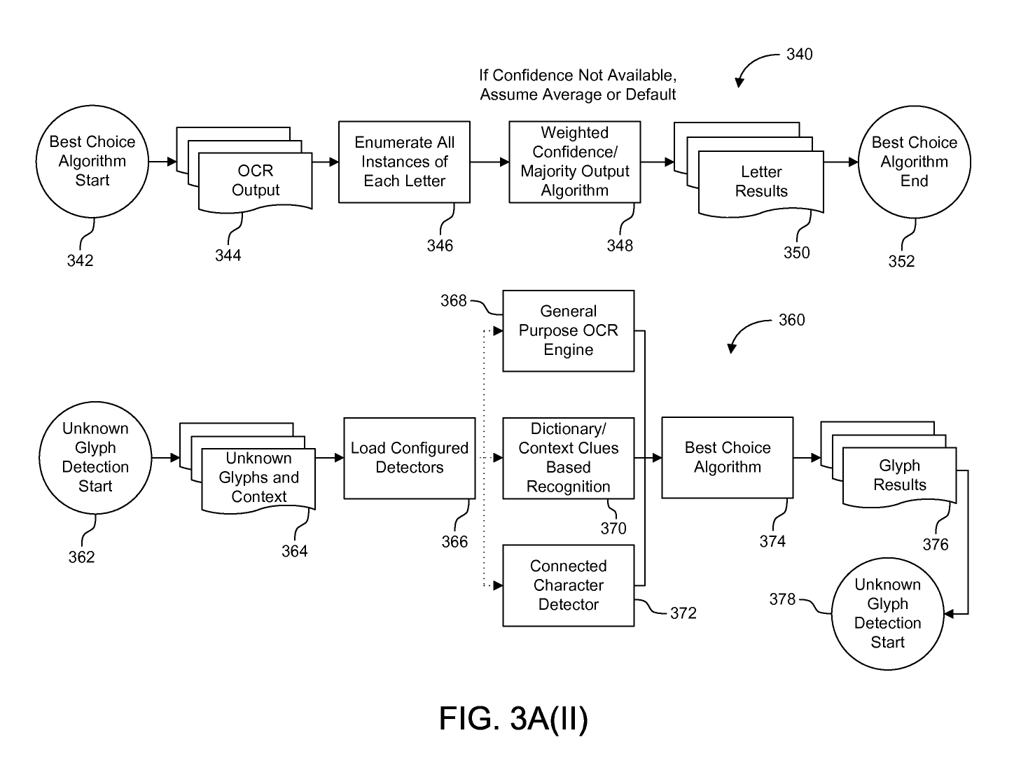

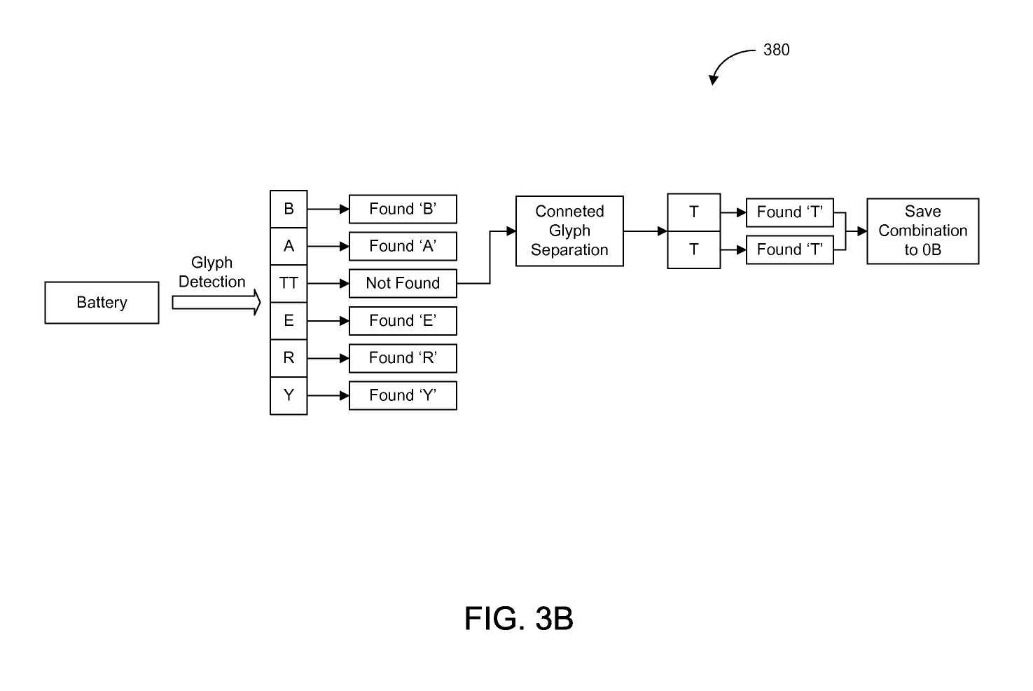

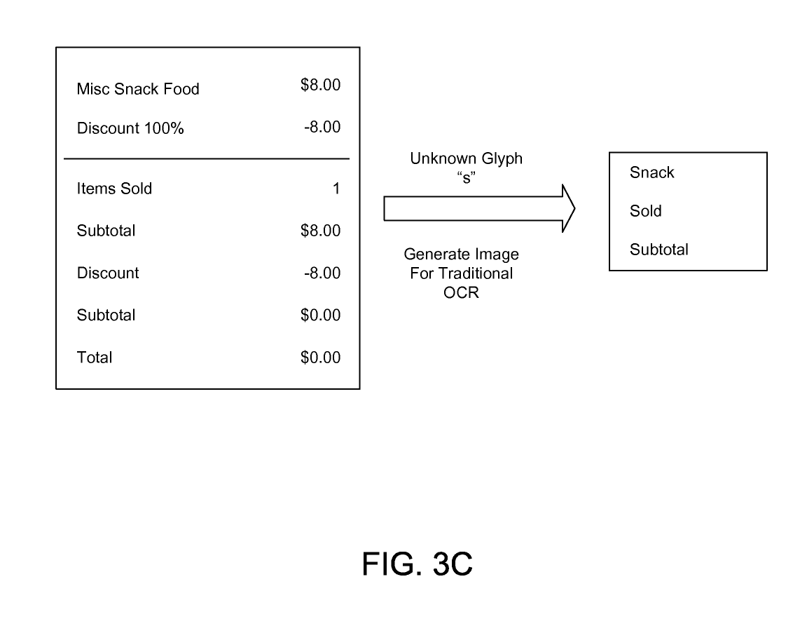

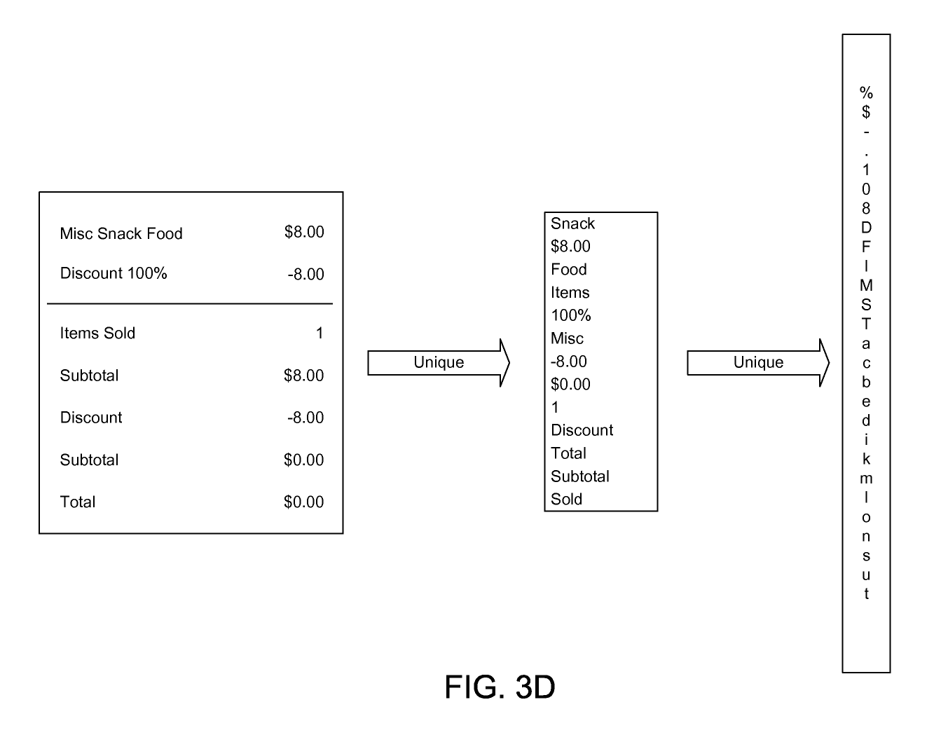

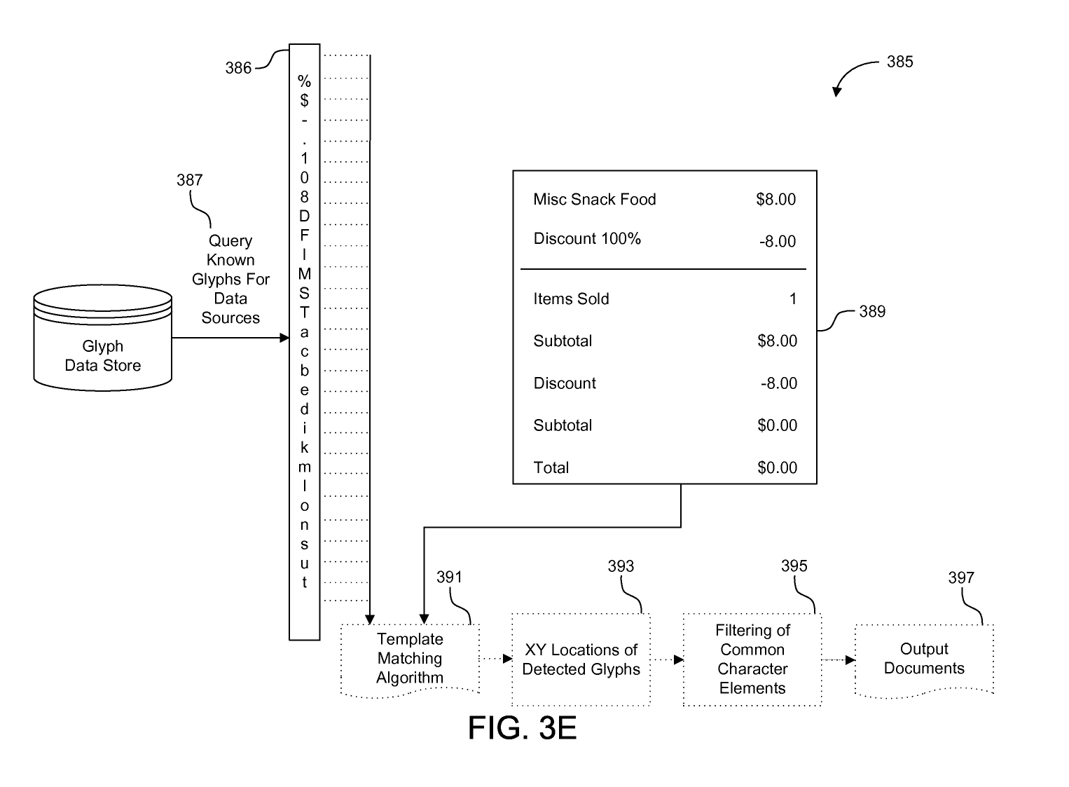

FIG. 3A, shown as FIGS. 3A(I) and 3A(II), is a flow chart of illustrative subroutines (300, 320, 340, 360) for identification of problem glyphs for reconstruction of words in a method for optical character recognition of a page, according to an illustrative embodiment.

In subroutine 300, a general purpose OCR routine is performed (routine 302), and unknown letters and word context 304 are identified. General purpose OCR engines A, B, through n are then used (e.g., processed in parallel, as shown, or serially) (steps 306, 308, 310), and a best choice algorithm (discussed below), in some implementations, is used to identify the letter results 312 (or other glyph results). This information (e.g., the letter result 312) is transmitted as general purpose OCR routine output (step 314) and is used in the reconstruction of words and/or the page.

Subroutine 320 is a dictionary/context clues-based recognition subroutine. The unknown letter(s)/glyph(s) 324 is/are identified (e.g., via subroutine 360, discussed below), along with word context, and a matching/spell check algorithm is run on each word (step 326), e.g., using a custom training set 328 which is updatable over time. Accuracy is evaluated based on known metadata and/or patterns (step 330), and the best results 332 (e.g., letter results) are identified, then returned (step 334) for use in the reconstruction of words and/or the page.

In subroutine 340, a best choice algorithm is performed. Upon the start (step 342) an OCR output 344 (e.g., from general purpose OCR routine output from subroutine 300) is used as an input. All instances of each letter are enumerated in step 346. The results are sorted by confidence value (step 348). If confidence values are not available, an average or default is assumed, in some implementations. Results 350 for the letter/glyph are identified, then returned (step 352) for use in the reconstruction of words and/or the page.

Subroutine 360 performs unknown glyph detection. Unknown glyph(s) and their context(s) 364 are identified, and configured detectors are loaded (step 366). In this example, three steps are then performed in parallel (although they may be performed serially)—a general purpose OCR engine operation (step 368) is performed (such as subroutine 300), a dictionary/contact clues based recognition operation (step 370) is performed (such as subroutine 320), and a connected character detector operation (step 372) is performed. A best choice algorithm operation (step 374) is performed to identify the most likely correct glyph result(s) 376, which are then returned (step 378) for use in the reconstruction of the words and/or the page.

FIG. 3B illustrates glyph detection of the word “BATTERY” as printed, for example, on a cash register receipt. Individual glyphs are identified and matched to known characters. In this example, each of the letters B, A, E, R, and Y were found in the database of known glyphs; however, the “TT” is identified as an individual glyph and is not found in the database. A “connected glyph separation” subroutine is then performed on the glyph to identify whether the glyph can be separated (i.e., could be broken into two or more portions) that would be recognized in the database. In this instance, the “TT” glyph was found to be separable and was separated. The two individual “T” glyphs were separately matched to the known glyph “T” in the database. The combined “TT” glyph is then saved to the database so that later glyph detection operations will recognize the “TT” glyph without having to perform a separation to identify individual glyphs. Similarly, combinations of known glyphs which appear regularly on a page, for example, repeated words on a cash register receipt, may be saved in the database, and the combined glyph representing the whole word may be identified immediately, rather than requiring it to be broken down into individual glyphs for identification.

FIG. 3C illustrates the mapping of unknown glyphs to words, e.g., to increase accuracy. Here, the system implementing the present algorithm instructs an external OCR engine to analyze multiple words having the same identified glyph. As shown in FIG. 3C, a single unknown glyph “S” appears on a document (e.g., in this example, a cash register receipt), where the glyph is found in three unique words: “Subtotal”, “Sold” and “Snack”. The three words are passed to the external OCR engine, and an accuracy determination/best choice algorithm is used to determine the most accurate output. In some implementations, the accuracy determination algorithm is similar to, the contextual-based algorithm described above. In other implementations, the algorithm is implemented as a simple majority. In other implementations, the algorithm is evaluated based on the perceived accuracy of the outputs combined with the known metadata.

FIG. 3D illustrates a first step in which each consolidated combination of glyphs on a page (e.g., a glyph-to-page mapping) is first identified. Here, each unique word, price, or number on a page that is separated from other words, prices, or numbers by a space is identified. The location of the unique word is stored. Each location (e.g., coordinate location, respective location respective to other words) of subsequent appearances of a given identified word is also stored, but it is not necessary to repeat the further segmentation step for each occurrence of the word. For each unique word, a further segmentation operation is performed to identify the unique individual glyphs that make up the unique words. Matching need only be performed for unique individual glyphs to identify them, as long as the locations of repeated occurrences of those glyphs in the unique words are mapped.

FIG. 3E illustrates an alternative embodiment 385 to identify glyphs in a document. Rather than performing a hash on a minimum set of glyphs, a scan is performed over the input document for each member of an input dataset to identify potential matches. This embodiment is beneficial where the training dataset is sufficiently limited. Instead of performing a hash operation then a lookup, the system implementing the algorithm performs a query to limit the input dataset 386 (e.g., based on the type of the input document, identifier associated with the document, metadata associated with the document), and then individually searches each glyph in the dataset 386 in the document 389 for matches.

As shown in FIG. 3E, a set of known characters (glyphs) 386 is loaded from a data store. The data store may optionally be reduced to a single input column of data (e.g., in a matrix or array). For each glyph of the queried data source 386, the document 389 is scanned to find a matching glyph. In some implementations, when a new input document 389 is received, each glyph (e.g., character) from the data store is scanned over the main document using a template matching algorithm operation 391. In some implementations, this may be a simple binary match. If the matching glyph is identified, the (x,y) location of the glyph within the document is stored. The location is associated to the matched glyph (step 393) at each occurrence to generate a glyph-to-page map. A glyph-to-page mapping structure includes, in some implementations, an associated (e.g., mapped) identification of one or more coordinates on the page at which the glyph appears. In some implementations, step 395 (filtering common character elements) is performed to reconcile overlapping and erroneous matches. For example, an “H” character may be detected as both an “H” and two lowercase “l”s and a dash “-”. Since the (x,y) mapping will list these as overlapping, it is possible to identify which character(s) is/are more likely (e.g., an “H” or a “1-1” combination) using techniques mentioned hereinabove, including, e.g., hinting rules and spell check. The final output document 397 is then produced. Thus, OCR can be performed using trained data set and have each of a few ten, hundred, or thousand computer cores, e.g., of a graphic processing unit (GPU), to scan each different glyph across the page for matches, without hashing and without segmentation.

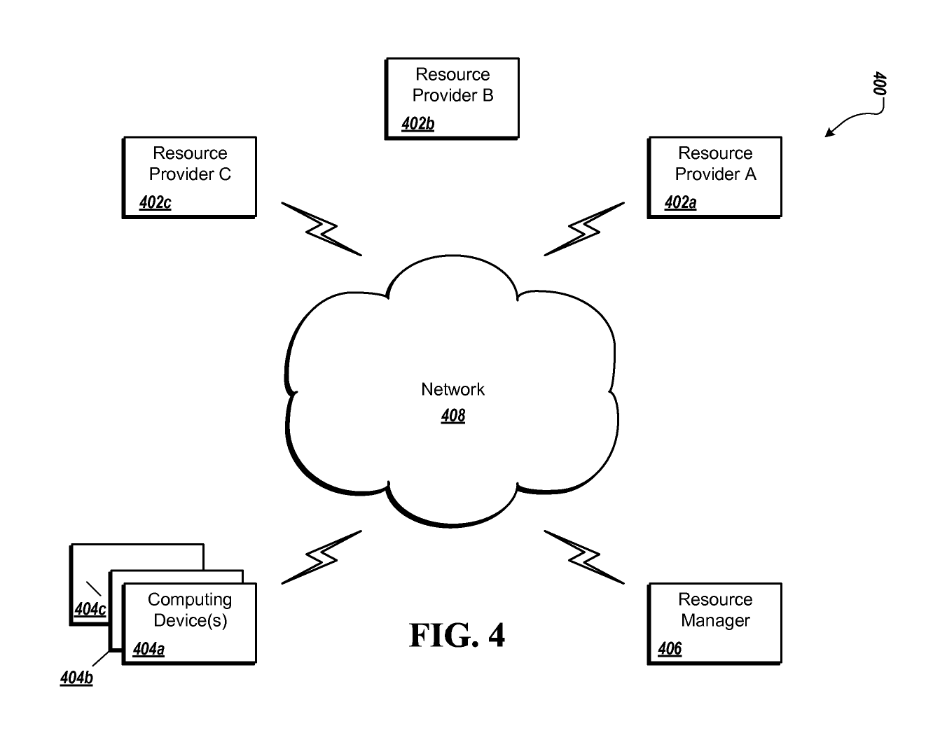

FIG. 4 shows an illustrative network environment 400 for use in the methods and systems for improved optical character recognition, as described herein. In brief overview, referring now to FIG. 4, a block diagram of an exemplary cloud computing environment 400 is shown and described. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

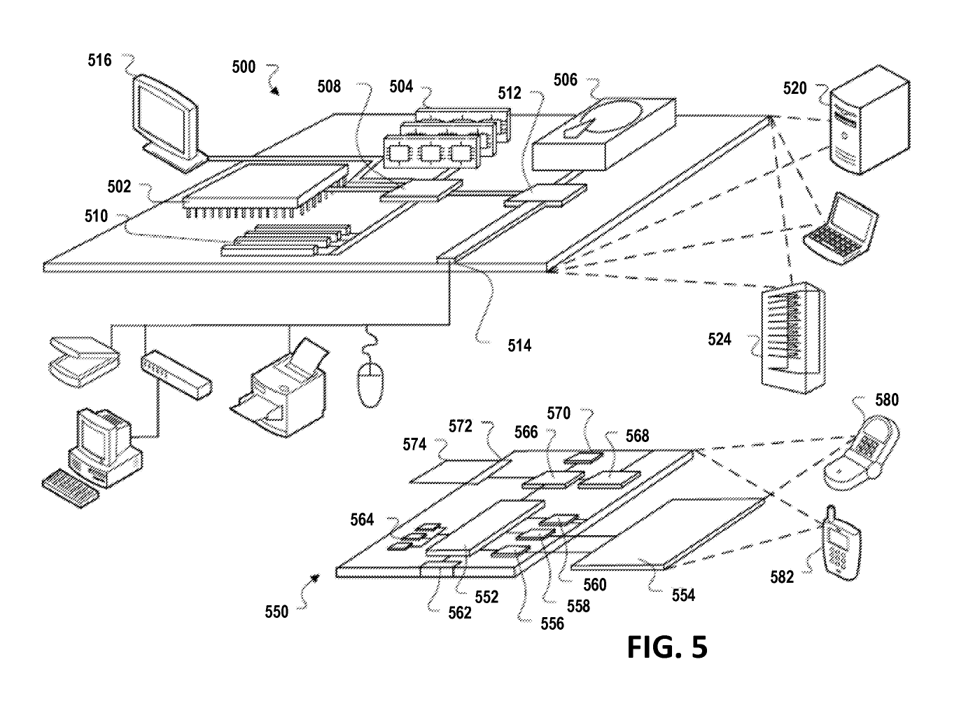

FIG. 5 shows an example of a computing device 500 and a mobile computing device 550 that can be used in the methods and systems described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for extracting rasterized text and/or other metadata from an image, the method comprising the steps of:
accessing, by a processor of a computing device, a first page of a first document (e.g., an electronic document, or a scanned physical document) comprising one or more pages;
performing A and/or B:
(A) identifying, by the processor, a set of unique words on the first page by performing a hashing algorithm and storing, as a word-to-page mapping structure, a representation (e.g. a hash) for each identified unique word and an associated (e.g., mapped) identification of one or more locations on the first page (e.g., one or more coordinates) at which said unique word appears; and
identifying, by the processor, a set of unique glyphs on the first page and, for each glyph, storing, as a glyph-to-word mapping structure, an associated (e.g., mapped) identification of one or more words of the set of unique words in which the glyph appears; and
reconstructing, by the processor, (i) the set of unique words using the glyph-to-word mapping structure and (ii) the arrangement of words on the first page using the word-to-page mapping structure;
(B) identifying, by the processor, a set of unique glyphs on the first page and, for each glyph, storing, as a glyph-to-page mapping structure, an associated (e.g., mapped) identification of one or more coordinates on the page at which the glyph appears; and reconstructing, by the processor, the arrangement of glyphs on the first page using the glyph-to-page mapping structure.

2. The method of claim 1, comprising identifying, by the processor, one or more image elements on the first page corresponding to graphical features not requiring further segmentation, and removing said one or more identified image elements from the first page prior to performance, or continued performance, of the hashing algorithm on the first page (e.g., removing lines and/or boxes from the first page prior to segmenting underlined words and/or words within a table on the first page).

3. The method of claim 1 or 2, comprising:
storing hinting information during the identifying of the set of unique glyphs; and
using the stored hinting information during the reconstructing step (e.g., thereby providing accurate reconstruction of identified glyphs into words and/or appropriate arrangement of words on the first page).

4. The method of claim 3, wherein the stored hinting information comprises one or more members selected from the group consisting of a hardcoded rule, a dictionary word lookup, a virtual machine hinting instruction of a recognized font file, and an instruction of a customized virtual machine.

5. The method of any one of the preceding claims, wherein one or both of (i) the step of identifying the set of unique words on the first page and (ii) the step of identifying the set of unique glyphs on the first page comprises using metadata identified by the processor to classify an identified image element on the first page as one of the unique words or one of the unique glyphs (e.g., wherein the metadata comprises one or more of a height, a width, and/or an aspect ratio of an identified image element on the first page).

6. The method of any one of the preceding claims, wherein the step of identifying the set of unique glyphs comprises identifying, by the processor, a segmented glyph that is not readily identifiable using a first OCR engine and identifying at least one of the one or more words in which the segmented glyph is determined by the processor to appear, then using a second OCR engine to identify the segmented glyph that was not identifiable using the first OCR engine, wherein the second OCR engine comprises one or more rules associated with glyphs surrounding the unknown segmented glyph in the one or more words in which the segmented glyph appears.

7. The method of any one of claims 1 to 5, wherein the step of identifying the set of unique glyphs comprises identifying, by the processor, a segmented glyph classified by a first OCR engine with a confidence score below a predetermined threshold, then classifying the segmented glyph using at least a second OCR engine (and, optionally, one or more subsequent OCR engines), then identifying, by the processor, a classification of the segmented glyph based on a confidence score achieved by the second and/or subsequent OCR engine(s).

8. The method of any one of the preceding claims, wherein one or more of (i) the step of identifying the set of unique words on the first page, (ii) the step of identifying the set of unique glyphs on the first page, and (iii) reconstructing the set of unique words and the arrangement of words on the first page, comprises using rules and/or data stored during a previous performance of the method of extracting rasterized text and/or other metadata of a second document (e.g., wherein the method is self-training).

9. The method of any one of the preceding claims, wherein the first document is a receipt (e.g., a printed receipt).

10. A system for extracting rasterized text and/or other metadata from an image, the system comprising a processor and a memory, the memory storing instructions that, when executed by the processor, cause the processor to:
access a first page of a first document (e.g., an electronic document, or a scanned physical document) comprising one or more pages;
perform (A) and/or (B):
(A) identify a set of unique words on the first page by performing a hashing algorithm and store, as a word-to-page mapping structure, a representation (e.g. a hash) for each identified unique word and an associated (e.g., mapped) identification of one or more locations on the first page (e.g., one or more coordinates) at which said unique word appears; identify a set of unique glyphs on the first page and, for each glyph, store, as a glyph-to-word mapping structure, an associated (e.g., mapped) identification of one or more words of the set of unique words in which the glyph appears; and reconstruct (i) the set of unique words using the glyph-to-word mapping structure and (ii) the arrangement of words on the first page using the word-to-page mapping structure;
(B) identify a set of unique glyphs on the first page and, for each glyph, store, as a glyph-to-page mapping structure, an associated (e.g., mapped) identification of one or more coordinates on the page at which the glyph appears; and reconstruct the arrangement of glyphs on the first page using the glyph-to-page mapping structure.

11. The system of claim 10, wherein the instructions cause the processor to identify one or more image elements on the first page corresponding to graphical features not requiring further segmentation, and remove said one or more identified image elements from the first page prior to performance, or continued performance, of the hashing algorithm on the first page (e.g., removing lines and/or boxes from the first page prior to segmenting underlined words and/or words within a table on the first page).

12. The system of claim 10 or 11, wherein the instructions cause the processor to store hinting information during the identifying of the set of unique glyphs, and use the stored hinting information during the reconstructing step (e.g., thereby providing accurate reconstruction of identified glyphs into words and/or appropriate arrangement of words on the first page).

13. The system of claim 12, wherein the stored hinting information comprises one or more members selected from the group consisting of a hardcoded rule, a dictionary word lookup, a virtual machine hinting instruction of a recognized font file, and an instruction of a customized virtual machine.

14. The system of any one of claims 10-13, wherein the instructions cause the processor to use metadata identified by the processor to classify an identified image element on the first page as one of the unique words or one of the unique glyphs (e.g., wherein the metadata comprises one or more of a height, a width, and/or an aspect ratio of an identified image element on the first page).

15. The system of any one of claims 10-14, wherein the instructions cause the processor to identify a segmented glyph that is not readily identifiable using a first OCR engine and identify at least one of the one or more words in which the segmented glyph is determined to appear, then use a second OCR engine to identify the segmented glyph that was not identifiable using the first OCR engine, wherein the second OCR engine comprises one or more rules associated with glyphs surrounding the unknown segmented glyph in the one or more words in which the segmented glyph appears.

16. The system of any one of claims 10-14, wherein the instructions cause the processor to identify a segmented glyph classified by a first OCR engine with a confidence score below a predetermined threshold, then classify the segmented glyph using at least a second OCR engine (and, optionally, one or more subsequent OCR engines), then identify, by the processor, a classification of the segmented glyph based on a confidence score achieved by the second and/or subsequent OCR engine(s).

17. The system of any one of claims 10-16, wherein the instructions cause the processor to use previously-stored rules and/or data to do any one or more of (i), (ii), and (iii), as follows: (i) identify the set of unique words on the first page, (ii) identify the set of unique glyphs on the first page, and (iii) reconstruct the set of unique words and the arrangement of words on the first page.

18. The system of any one of claims 10-17, wherein the first document is a receipt (e.g., a printed receipt).

19. A method for extracting rasterized text and/or other metadata from an image, the method comprising the steps of:
accessing, by a processor of a computing device, a first page of a first document (e.g., an electronic document, or a scanned physical document) comprising one or more pages;
accessing, by the processor, a set of glyphs from a glyph data store;
for each member of the set of glyphs, scanning, by the processor, the first page of the first document to identify each occurrence of the member on the page, identifying an (x,y) coordinate for each occurrence, and generating a resulting glyph-to-page mapping structure;
reconstructing, by the processor, the arrangement of glyphs on the first page using the glyph-to-page mapping structure.

20. The method of claim 19, further comprising applying, by the processor, a filter to identify and reconcile overlapping and/or erroneous matches in the glyph-to-page mapping structure prior to (or contemporaneous with) the reconstructing of the arrangement of glyphs on the first page.
